(19) United States
(12) Patent Application Publication
(10) Pub. No.: US 2006/0261220 A1
(43) Pub. Date: Nov. 23, 2006

(54) Storage compartment with display support

(75) Inventors: Song-yik Lee, Suwon-si (KR); Dae-jung Lee, Gwangju-si (KR); Seok-jun Son, Gwangju-si (KR); Seon-ho Kim, Gwangju-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/406,306

(22) Filed: Apr. 19, 2006

Related U.S. Application Data
(60) Provisional application No. 60/682,393, filed on May 19, 2005.

(51) Int. Cl. G12B 9/00; F25B 49/00; A47B 96/06; F16M 3/00; A47B 96/04

(52) U.S. Cl. 248/27.1; 248/205.1; 62/126; 248/645; 312/401

(57) ABSTRACT

Embodiments of the present invention relate to a refrigerator having a main body, enclosing a storage compartment, a door to provide access to the storage compartment, and a display to display a picture. The door may include a corresponding display accommodator to accommodate the display, a support member to support the display and to move the display between an accommodation position, where the display is accommodated in the display accommodator, and a separation position, where the display is separated from the display accommodator, a driver to move the support member to the accommodation position and the separation position, and a controller to detect whether the display has been separated from the support member and to drive the driver to move the support member from the separation position to the accommodation position. Thus, embodiments of the present invention provide a refrigerator permitting easy attachment and detachment of a display.

### CROSS-REFERENCE TO RELATED APPLICATIONS

This application claims the priority benefit of U.S. Provisional Application No. 60/682,393, filed May 19, 2005, in the U.S. Patent and Trademark Office, the disclosure of which is incorporated herein by reference.

### BACKGROUND OF THE INVENTION

1. Field of the Invention

Embodiments of the present invention relate, at least as discussed herein, to a refrigerator having a display, and more particularly, to a refrigerator having a support configuration for a display.

2. Description of the Related Art

Generally, refrigerators have a main body enclosing a storage compartment and a door to gain access to the storage compartment. The refrigerator performs various operations in addition to storing food. In particular, recently refrigerators have included a display, e.g., to provide access to the Internet.

As an example, Korean Patent Application No. 2003-63256 discusses a touch screen attachment device for a refrigerator. Here, the conventional touch screen attachment device includes a supporter for supporting the touch screen, a housing to accommodate the support, an electric motor to rotate the support forward and backward, and a switch to drive the electric motor.

Here, when the touch screen is supported by the support, to be accommodated in the housing, a user can press the switch to rotate the support forward, thereby separating the touch screen from the support. If a user presses the switch again, the support rotates backward to again be accommodated in the housing.

However, in this conventional refrigerator, the user must press the switch a second time to accommodate the support into the housing once the touch screen has separated from the support.

Further, if the touch screen is separated from the supporter, there must also be a groove for later accommodating return of the touch screen in the housing of the convention refrigerator, thereby resulting in an unsatisfactory external appearance.

### SUMMARY OF THE INVENTION

Accordingly, it is an aspect of embodiments o the present invention to provide a refrigerator with a display that easily attaches and detaches from a display accommodator.

In addition, it is another aspect of embodiments of the present invention to provide a refrigerator with an attractive external appearance even if a display is separated from the display accommodator.

To achieve the above and/or other aspects and advantages, embodiments of the present invention include a storage compartment, including a display accommodator to accommodate a display, a support member to support the display and to move the display between an accommodation position, where the display is accommodatable in the display accommodator, and a separation position, where the display is separatable from the display accommodator, a driver to move the support member to/from the accommodation position and/or the separation position, and a controller to detect whether the display is separate from the support member and to drive the driver to correspondingly move the support member to/from the separation position to/from the accommodation position.

The storage compartment may be a refrigerator. In addition, the storage compartment may include a display accommodatable in the display accommodator. The display may include a connection port and the support member includes a connector to couple with the connection port of the display.

The display accommodator may be formed in a door providing access to the storage compartment.

In addition, the controller may detect whether the display is supported by the support member and drives the driver to move the support member from the separation position to the accommodation position. Here, the support member may be provided in a lower portion of the display accommodator to rotate between the accommodation position and the separation position. The storage compartment may further include a support slider in the support member and a support slider guide to be moved by the driver and to guide the support slider to rotate the support member between the accommodation position and the separation position. In addition, the storage compartment may include an elastic member to press the support member toward the accommodation position.

The storage compartment may include a cover member to move to an opening position to open the display accommodator for access of the display to the support member. The cover member may move between the opening position and a cover position, to cover the display accommodator when the display is separate from the support member In addition, the display accommodator may include a cover member guide to guide the cover member forward and backward, and the cover member includes a cover slider to be guided by the cover member guide.

The storage compartment may include a connection member connected to the driver and the cover slider to move the cover slider along the cover member guide by the driver. The connection member may move in a traverse direction to a moving direction of the cover member by the driver and include a cover member slider guide to guide the cover slider by movement of the connection member. In addition, the cover slider guide may include an inclination guide inclined toward the moving direction of the connection member. Further, the cover slider guide may further include a parallel guide connected with the inclination guide and formed in the moving direction of the connection member.

The storage compartment may include a support slider provided in the support member and a support slider guide, movable by the driver, to guide the support slider to rotate the support member between the accommodation position and the separation position, wherein the support slider rotates between the accommodation position and the separation position when the cover slider is guided by the parallel guide and the inclination guide respectively. The support slider guide may be provided in the connection member. In addition, the driver may include a driving motor and a pinion gear to be rotated by the driving motor, and the connection member may include a rack gear to engage the pinion gear.

The controller may further include a sensor provided in the support member to detect whether the display is separated and/or mounted with respect to the support member. The controller may still further include a control unit to control the driver to rotate the support member to the accommodation position and the separation position.

To achieve the above and/or other aspects and advantages, embodiments of the present invention include a storage compartment including a display accommodator having an opening to accommodate a display, a support member to support the display, a cover member to move to an opening position and/or cover position to respectively open and/or close the opening of the display accommodator, and a driver to drive the cover member to move to the opening position and/or the cover position.

The cover member may move between the opening position and cover position to correspondingly open and cover the opening of the display accommodator based upon the display being respectively separated from or inserted into the support member.

In addition, the storage compartment may be a refrigerator. In addition, the storage compartment may include a display accommodatable in the display accommodator. The display accommodator may be formed in a door providing access to the storage compartment.

The display accommodator may include a cover member guide to guide the cover member forward and backward, and the cover member includes a cover slider to be guided by the cover member guide.

In addition, the storage compartment may include a connection member connected to the driver and the cover slider to move the cover slider along the cover member guide by the driver. The connection member may move in a traverse direction to a moving direction of the cover member, by operation of the driver, and include a cover slider guide to guide the cover slider by movement of the connection member.

The cover slider guide may include an inclination guide inclined toward the moving direction of the connection member. In addition, the cover slider guide may further include a parallel guide connected with the inclination guide and formed in the moving direction of the connection member.

The driver may include a driving motor and a pinion gear to rotate, by operation of the driving motor, and the connection member includes a rack gear to engage the pinion gear.

The support member may rotates, by operation of the driver, between an accommodation position, where the display is accommodated in the display accommodator, and a separation position, where the display is separated from the display accommodator. In addition, the storage compartment may further include a sensor to detect whether the display is attached and/or detached to the support member and to apply a corresponding operation signal to the driver to rotate the support member respectively to/from the separation position to/from the accommodation position. Still further, the storage compartment may include a control unit to control the driver to rotate the support member to/from the accommodation and/or the separation positions.

The cover member may move from a first side to a second side of the opening of the display accommodator. The first side of the display accommodator may include a cover member accommodator to accommodate the cover member. The display accommodator may further include a cover guide to guide the cover member.

To achieve the above and/or other aspects and advantages, embodiments of the present invention include a refrigerator including a main body enclosing a storage compartment and a door to provide access to the storage compartment, further including a display, a display accommodator formed in the door to accommodate the display, a support member to support the display and to move the display between an accommodation position, where the display is accommodated in the display accommodator, and a separation position, where the display is separated from the display accommodator, a driver to move the support member to/from the accommodation position and the separation position, a cover member to move between an opening position, to open an opening of the display accommodator, and a cover position, to cover the opening of the display accommodator, when the display is separated from the support member by the driver, and a controller to detect whether the display is supported by, and whether the display is separated from, the support member and to correspondingly drive the driver to move the support member from the separation position to the accommodation position.

The refrigerator may include a connection member provided between the driver and the cover member to move the cover member by the driver. The driver may include a driving motor and a pinion gear to rotate, by operation of the driving motor, and the connection member includes a rack gear to engage the pinion gear.

To achieve the above and/or other aspects and advantages, embodiments of the present invention include a storage compartment display accommodation method, including providing support for a display, with the support being capable of moving the display between an accommodation position, where the display is accommodatable in a display accommodator, and a separation position, where the display is separatable from the display accommodator, and moving the display accomodator to/from the accommodation position and/or the separation position based upon a detection of whether the display is separate from the display accommodator.

To achieve the above and/or other aspects and advantages, embodiments of the present invention include a storage compartment display accommodation method, including providing support for a display, with the support being capable of moving the display between an accommodation position, where the display is accommodatable in a display accommodator, and a separation position, where the display is separatable from the display accommodator, and moving a cover member to an opening position and/or cover position to open and/or respectively open or close an opening of the display accommodator.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a refrigerator according to an embodiment of the present invention;

FIG. 2 is another illustration of a refrigerator, according to an embodiment of the present invention, where a display is separated from the refrigerator;

FIG. 3 illustrates a rear exploded perspective view of a support member and a cover unit of a refrigerator according to the embodiment of the present invention;

FIGS. 4 through 6 illustrate perspective and sectional views of the support member and the cover unit of a refrigerator, such as that of in FIG. 1, according to embodiments of the present invention;

FIGS. 7 through 9 illustrate perspective and sectional views of a support member and a cover unit, to separate a display of a refrigerator, according to embodiments of the present invention;

FIGS. 10 through 12 illustrate perspective and sectional views of a support member and a cover unit, after a display has been separated from the refrigerator, according to an embodiment of the present invention; and

FIGS. 13 and 14 illustrate perspective and sectional views of another embodiment of a cover unit of a refrigerator, according to an embodiment of the present invention.

### DETAILED DESCRIPTION OF THE PREFERRED EMBODIMENTS

Reference will now be made in detail to embodiments, at least as discussed herein, of the present invention, examples of which are illustrated in the accompanying drawings, wherein like reference numerals refer to the like elements throughout. Embodiments are described below to explain the present invention by referring to the figures.

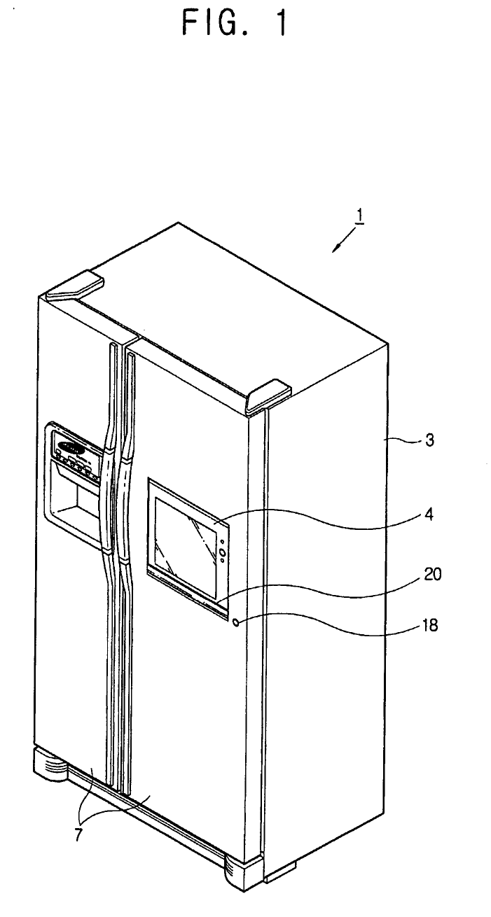

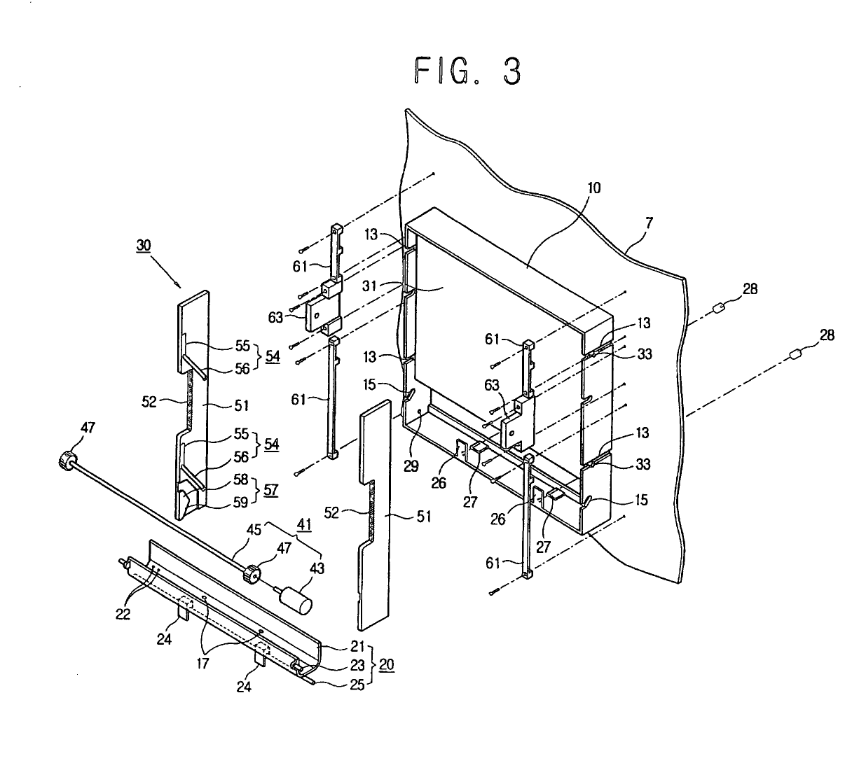

As illustrated in FIGS. 1 through 3, and according to embodiments of the present invention, a refrigerator 1 may include a main body 3 enclosing a storage compartment (not shown), a door 7 to provide access to the storage compartment of the main body 3, a display 4 to display a picture, a display accommodator 10 formed on the door 7 to accommodate the display 4, and a support member 20 to support the display 4 for separation of the display from the main body 3. The refrigerator 1, according to an embodiment of the present invention, may further include a cover unit 30 having a cover member 31 to cover the display accommodator 10 when the display 4 is removed/separated from the support member 20, as shown in FIG. 3.

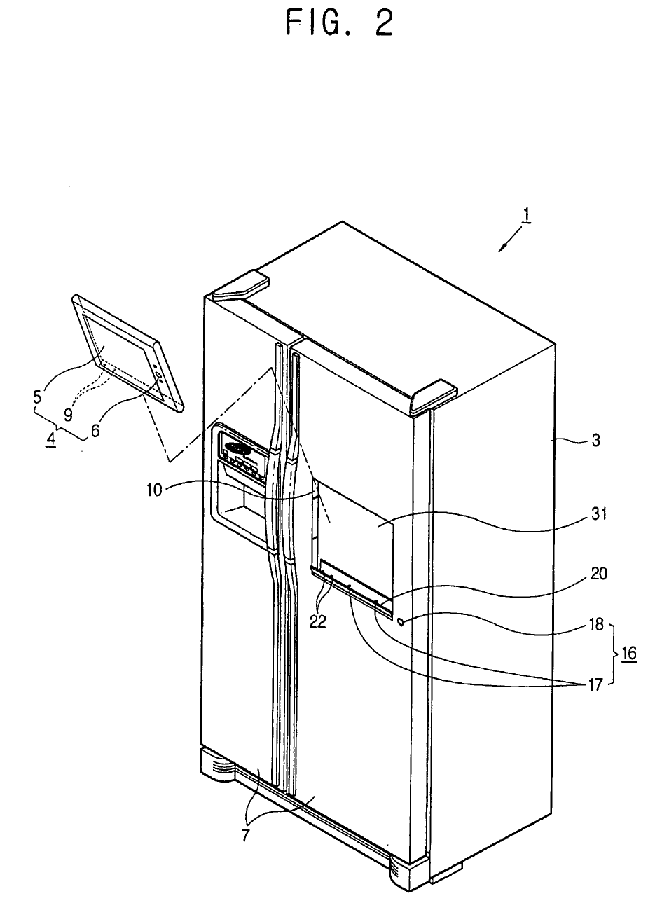

The main body 3 may include the storage compartment (not shown), such as a freezing compartment and/or a refrigerating compartment, e.g., to store food, and a freezing apparatus (not shown) to supply cooling air to the storage compartment (not shown). As an example, and as shown in FIGS. 1 and 2, the main body 3 may be a side by side refrigerator, with the storage compartment (not shown) of the main body 3 being similarly provided with a pair on right and left sides thereof, e.g., to be open and closed by the door 7.

As further shown in FIGS. 1 and 2, the display 4 may include a flat display panel 5 such as an LCD panel, e.g., to display a picture, and a driving circuit (not shown) to drive the flat display panel 5. The display 4 may include a control button 6 for input and/or selection of information, and a connection port 9 to be connected with a connector 22 of the support member 20 (to be described later) and receive electric power, for example. As another example, the display 4 may further include a battery (not shown) to store power supplied by the connection port 9. The flat display panel 5 may be provided as a touch screen to input information more easily. The display 4 may be installed with a wireless data sender and receiver (not shown) to wirelessly send and receive data with respect to external electronic devices, for example. Thus, the display 4 may also provide an access to the Internet.

The connection port 9 can be connected with the connector 22 of the support member 20 to send and receive an electric signal, such as a picture signal, as well as to receive electric power.

According to an embodiment of the present invention, the display accommodator 10 may be depressed on the door 7 to accommodate reception of the display 4. The display accommodator 10 may further include an opening 11 to accommodate the display 4 reception. As shown in FIGS. 2 and 3, according to an embodiment of the present invention the display accommodator 10 may be opened forward and backward to accommodate the cover member 31, with the display accommodator 10 including cover member guides 13 to guide the cover member 31 and a support member guide 15 to guide the support member 20.

The cover member guides 13 may be plurally provided on opposite sides of the display accommodator 10 to guide the cover member 31 forward and backward, as shown in FIG. 3. The cover member guides 13 can be arranged to accommodate and guide cover sliders 33 of the cover member 31 (to be described later). As an example, the cover member guides 13 may be paired on opposite sides of the display accommodator 10, respectively.

The support member guide 15 may be provided along a lower part of the display accommodator 10 to rotatably guide the support member 20 forward and backward and arranged to accommodate and guide a support slider 23 of the support member 20 (to be described later). As an example, there may be a support member guide 15 along lower opposite sides of the display accommodator 10, respectively.

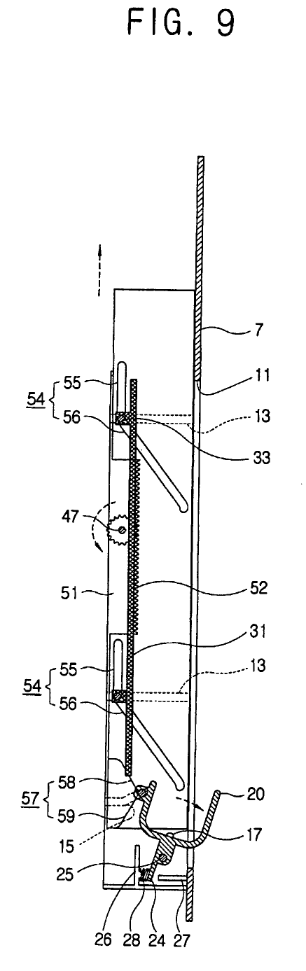

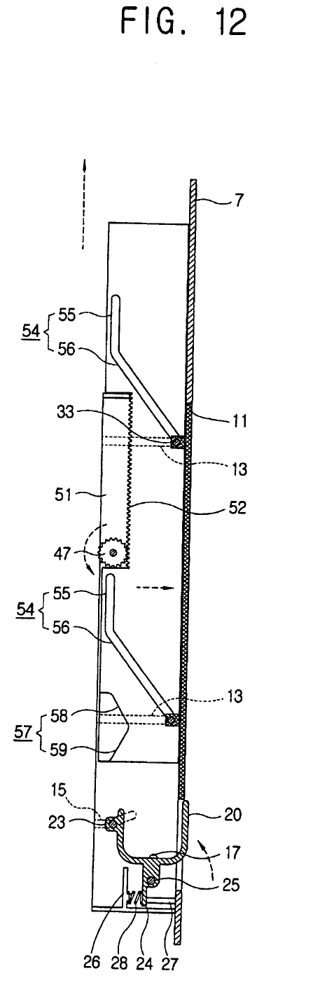

Thus, the cover member 31 may be accommodated with the display accommodator 10 and guided, e.g., by the cover member guides 13, to rotate forward and backward. Here, the support member 20 can be accommodated in the lower part of the display accommodator 10 and guided by the support member guide 15 to rotate, as shown in FIGS. 9 and 12.

As shown in FIGS. 9 and 12, the support member 20 can be arranged to rotate between an accommodation position, where the display 4 is accommodated in the display accommodator 10, and a separation position, where the display 4 is separated from the display accommodator 10. The support member 20 may include an accommodating supporter 21 to accommodate a lower part of the display 4 and the connector 22, which is provided in the accommodating supporter 21 to connect with the connection port 9 of the display 4 when the display 4 is accommodated in the accommodating supporter 21, as shown in FIG. 3. The support member 20 may include the support slider 23, to be guided by the support member guide 15, and a hinge shaft 25 to rotatably support the support member 20. The support member 20 may move between the accommodation position and the separation position by a driver 41 (to be described later). The support member 20 may further be provided with an elastic member 28 to press the support member 20 toward the accommodation position. Also, the support member 20 may be provided with a controller 16 to drive the driver 41, thereby moving the support member 20 from the separation position to the accommodation position, as shown in FIG. 2.

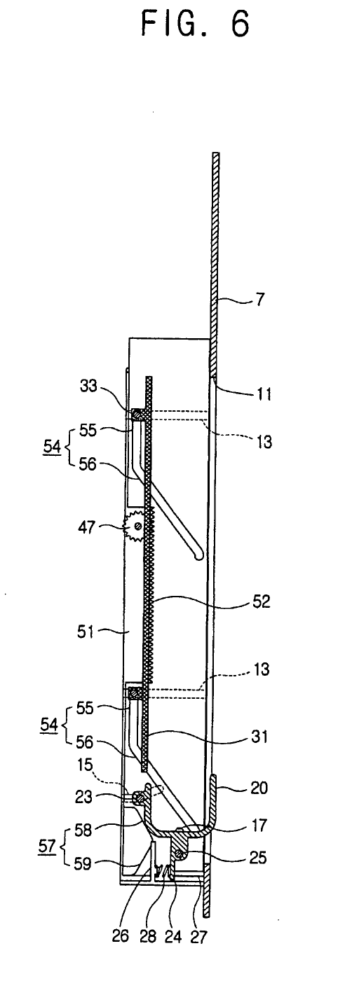

The support slider 23 protrudes from opposite sides of the support member 20, as shown in FIG. 3. Accordingly, the support slider 23 can be guided by a support slider guide 57 (to be described later), moved by the driver 41, to allow the support member 20 to rotate between the accommodation position and the separation position, as shown in FIGS. 6 and 9.

Here, the hinge shaft 25 is arranged to integrally rotate with the accommodation supporter 21, in a lower part of the accommodation supporter 21, shown in FIG. 3, such that opposite ends of the hinge shaft 25 are rotatably coupled to a hinge shaft supporter 29 provided in the lower part of the display accommodator 10. A first side of the hinge shaft 25 can be arranged with an elastic member presser 24 to integrally rotate with the hinge shaft 25.

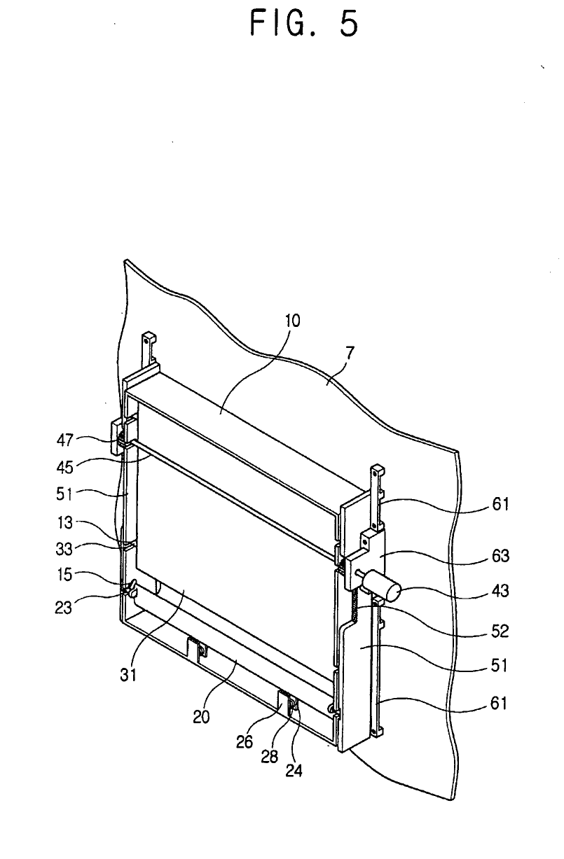

The elastic member 28 may be shaped like a coil spring, such that a first side of the elastic member 28 is supported by an elastic member supporter 26, provided in the lower part of the display accommodator 10, with a second side thereof being supported by the elastic member presser 24, as shown in FIGS. 3 and 5. The elastic member 28 can, thus, press the elastic member presser 24 to dispose the support member 20 in the accommodation position. However, if the support slider 23 is guided by the support slider guide 54 by overcoming elastic force of the elastic member 28, the support member 20 will rotate from the accommodation position to the separation position.

A stopper 27 may be provided along the lower part of the display accommodator 10 to restrain the elastic member presser 24 from rotating. Thus, according to this embodiment, the support member 20 may stop rotating in the accommodation position, as shown in FIG. 6.

The controller 16 may drive the driver 41 to detect whether the display 4 is separated from the support member 20 and to rotate the support member 20 from the separation position to the accommodation position. Similarly, the controller 16 may drive the driver 41 to detect whether the display 4 is supported by the support member 20 and to rotate the support member 20 from the separation position to the accommodation position. The controller 16 may include a sensor 17, provided in the support member 20, to detect whether the display 4 is separated or mounted with respect to the support member 20, as shown in FIGS. 2 and 3. The controller 16 may further include a control unit 18 to control the driver 41 to rotate the support member 20 between the accommodation position and the separation position, as shown in FIGS. 1 and 2.

Here, in this embodiment, the sensor 17 may be provided in the accommodation supporter 21 to detect whether the display 4 is separated from the support member 20 and to control the driver 41 to rotate the support member 20 from the separation position to the accommodation position. Similarly, the sensor 17 may detect whether the display 4 is supported by the support member 20 and control the driver 41 to rotate the support member 20 from the separation position to the accommodation position.

Accordingly, if a user separates the display 4 from the support member 20, the support member 20 may automatically rotate from the separation position to the accommodation position according to detections by the sensor 17. Similarly, if a user mounts the display 4 in the support member 20, the support member 20 may automatically rotate from the separation position to the accommodation position according to detections by the sensor 17.

The control unit 18 may be provided in the door 7, e.g., to be controlled by a user, as shown in FIGS. 1 and 2. The control unit 18 may be operated by a user and may control the driver 41 to rotate the support member 20 from the accommodation position to the separation position. Thus, when a user correspondingly actuates the control unit 18, e.g., when the display 4 is accommodated in the display accommodator 10, the support member 20 may rotate from the accommodation position to the separation position. Further, in an embodiment of the present invention, the control unit 18 may control the driver 41 to move the cover member 31 from a cover position to an opening position by being pressed by a user.

Here, the cover unit 30 may include the cover member 31, a driver 41 to drive the cover member 31 and the support member 20, and a connection member 51 to move the cover member 31 and the support member 20, e.g., by the driver 41, as shown in FIG. 3.

The cover member 31 may be movable between an opening position, to open the opening 11 of the display accommodator 10, and a covering position, to cover the opening 11 of the display accommodator 10 when the display 4 is separated from the support member 20, as shown in FIGS. 9 and 12. In an embodiment of the present invention, the cover member 31 may be shaped like a plate for accommodation in the display accommodator 10. The guide cover sliders 33 may protrude from opposite sides of the cover member 31 for accommodation and may further be guided to the cover member guides 13 of the display accommodator 10, as shown in FIG. 3.

The guide cover sliders 33 may be provided in pairs on opposite sides of the cover member 31 respectively corresponding to the different cover member guides 13 of the display accommodator 10, as shown in FIG. 3. The guide cover sliders 33 may be guided by the cover slider guide 54 of the connection member 51 (to be described later), for example, for moving the cover member 31 forward and backward.

Again, the driver 41 may move the support member 20 between the accommodation position and the separation position. In addition, the driver 41 may move the cover member 31 between the opening position and the cover position. Alternatively, separate drivers may be provided to drive the support member 20 and the cover member 31 respectively. As shown in FIG. 3, the driver 41 may include a driving motor 43 and pinion gears 47 to be rotated by the driving motor 43.

The driving motor 43 may be supported by a first side of the display accommodator 10, with the pinion gears 47 being provided as a pair corresponding to a pair of connection members 51 (to be described later). The respective pinion gears 47 can be connected by a rotation shaft 45 and rotated by the driving motor 43, for example. The driving motor 43 and the rotation shaft 45 may also be supported by a rotation shaft support 63, as shown in FIG. 3.

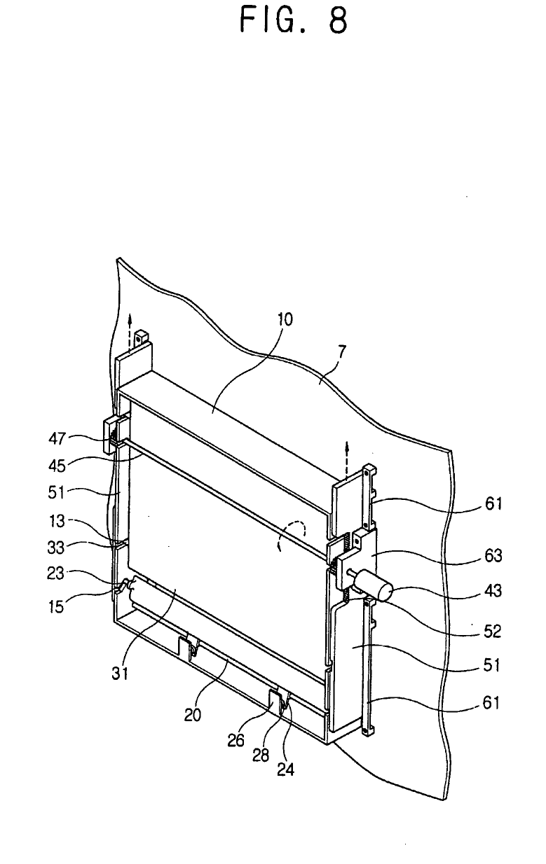

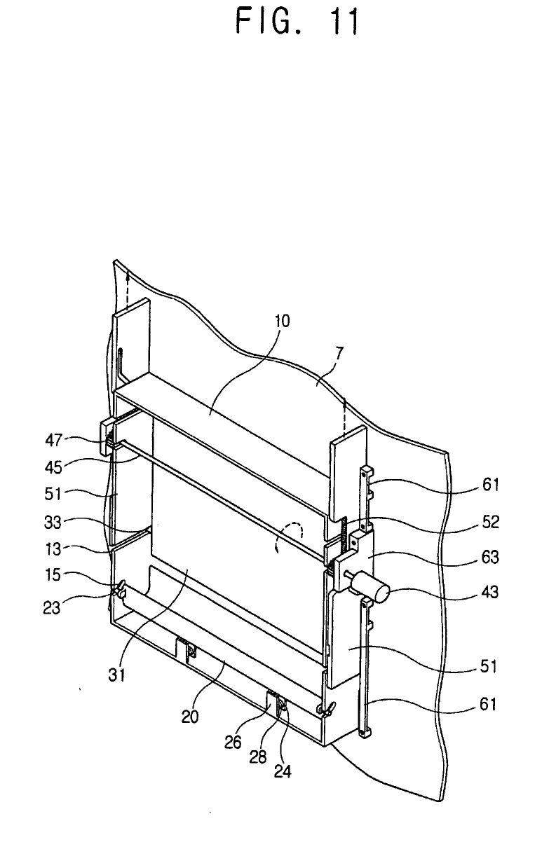

As further shown in FIG. 3, the connection members 51 may be shaped like a long plate, provided on opposite sides of the display apparatus 10, and connected with the driver 41 and the guide cover sliders 33 to move the guide cover sliders 33 along the cover member guides 13. Here, the connection members 51 can be moved in a traverse direction, with respect to a moving direction of the cover member 31. The connection members 51 may further be provided with the cover slider guide 54 to guide the guide cover sliders 33 through movement of the connection members 51. The connection members 51 can be provided with the support slider guide 57, and moved by the driver 41 to guide the support slider 23 to rotate the support member 20 between the accommodation position and the separation position. The connection members 51 may further be provided with a rack gear 52, engaged with the pinion gears 47, and guided by the connection member guide 61 respectively provided on opposite sides of the display accommodator 10 and moved by the driver 41, for example, in a vertical direction, as shown in FIGS. 5, 8 and 11.

The cover slider guide 54 may be elongatedly depressed in a plate surface of the connection members 51 to accommodate and guide the guide cover sliders 33. Here, the cover slider guide 54 may include an inclination guide 56, inclined in a moving direction of the connection members 51, and a parallel guide 55, formed in the moving direction of the connections members 51, as shown in FIG. 3.

The parallel guide 55 can be provided on an upper part of the inclination guide 56, communicating with the inclination guide 56 and accommodating and guiding the guide cover sliders 33. While the parallel guide 55 guides the guide cover sliders 33, the cover member 31 may not move, and the support slider 23 can be moved by the support slider guide 57 to move the support member 20 from the accommodation position to the separation position, as shown in FIGS. 6 and 9.

The inclination guide 56 may be inclined forward along a lower part of the parallel guide 55, and accommodate and guide the guide cover sliders 33, as shown in FIG. 3. While the inclination guide 56 guides the guide cover sliders 33, the cover member 31 moves between the opening position and the cover position. The support slider 23 moves by the support slider guide 57 to move the support member 20 between the accommodation position and the separation position, as shown in FIGS. 9 and 12.

The support slider guide 57 may be depressed in the plate surface of the connection members 51, accommodating and guiding the guide cover sliders 33, as shown in FIG. 3, and may be provided along a lower part of the cover slider guide 54 to guide the guide cover sliders 33. The support slider guide 57 may further include a first support guide 58, inclined forward, and a second support guide 59, inclined backward, along a lower part of the first support guide 58.

The first support guide 58 may be provided along an upper part of the second support guide 59 to communicate with the second support guide 59, and accommodates and guides the support slider 23. While the parallel guide 55 guides the guide cover sliders 33, the first support guide 58 may guide the support slider 23 and move the support member 20 from the accommodation position to the separation position, as shown in FIGS. 6 and 9.

The second support guide 59 may be provided along a lower part of the first support guide 58, accommodating and guiding the support slider 23, to guide the support slider 23 and move the support member 20 between the accommodation position and the separation position while the inclination guide 56 guides the guide cover sliders 33, as shown in FIGS. 9 and 12. As the elastic member 28 presses the support member 20 to be disposed in the accommodation position, the support slider 23 contacts a rear surface of the first and second support guides 58 and 59 while the support slider 23 moves, as shown in FIGS. 9 and 12. If the connection members 51 are further lifted up, the support slider 23 is separated to a lower part of the support slider guide 57. At this time, the support member 20 would be disposed in the accommodation position by the elastic member 28, as shown in FIG. 12.

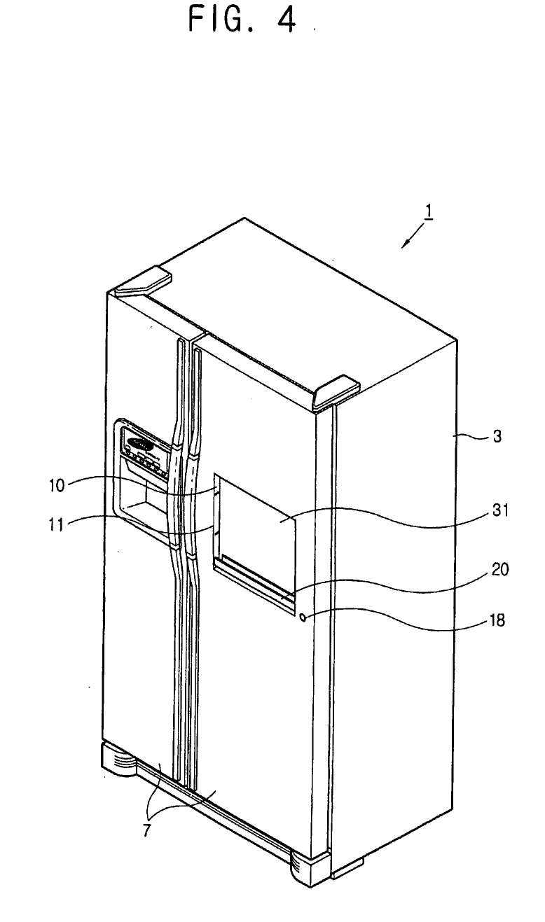

With this configuration, the operation process of the support member 20 and the cover member 31 of the refrigerator 1, according to this embodiment of the present invention, will now be further described with reference to FIGS. 4 through 12. In these illustrated embodiments, the display 4 is not shown in FIGS. 4 through 12 to illustrate the operation of the support member 20 and the cover member 31 in further detail.

Separating of the display 4 from the support member 20 will now be further described. As shown in FIGS. 4 through 6, the support member 20 can be disposed in the accommodation position, while the cover member 31 is disposed in the opening position. At this time, the display 4 would be in the support member 20. Here, the guide cover sliders 33 of the cover member 31 are positioned along the top of the cover slider guide 54 of the connection members 51. As shown in FIG. 6, the support slider 23 of the support member 20 is positioned along the top of the support slider guide 57 of the connection members 51.

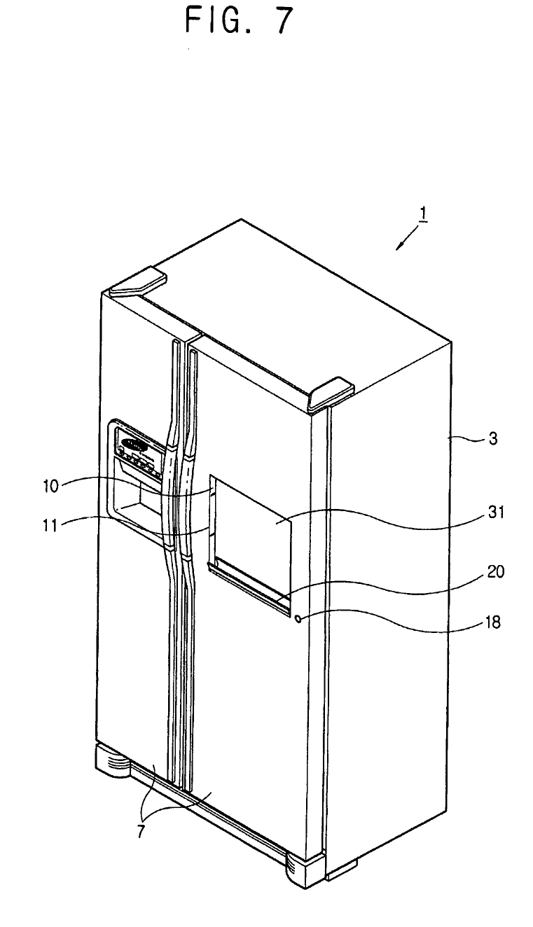

Accordingly, if a user actuates the control unit 18, the driving motor 43 may operate and rotate the pinion gears 47, thereby lifting up the rack gear 52 and the connection members 51, engaged with the pinion gears 47, by rotating the pinion gears 47, as shown by FIGS. 7 through 9. At this time, the driving motor 43 permits the connection members 51 to be lifted so that the guide cover sliders 33 move only the parallel guide 55, as shown in FIG. 9. Then, the cover member 31 may remain in the opening position. Here, the support slider 23 of the support member 20 moves along the first support guide 58 of the support slider guide 57, thereby rotating the support member 20 from the accommodation position to the separation position. Accordingly, according to an embodiment of the present invention, a user may remove the display 4 accommodated in the support member 20, thereby separating it from the support member 20, as shown in FIG. 2.

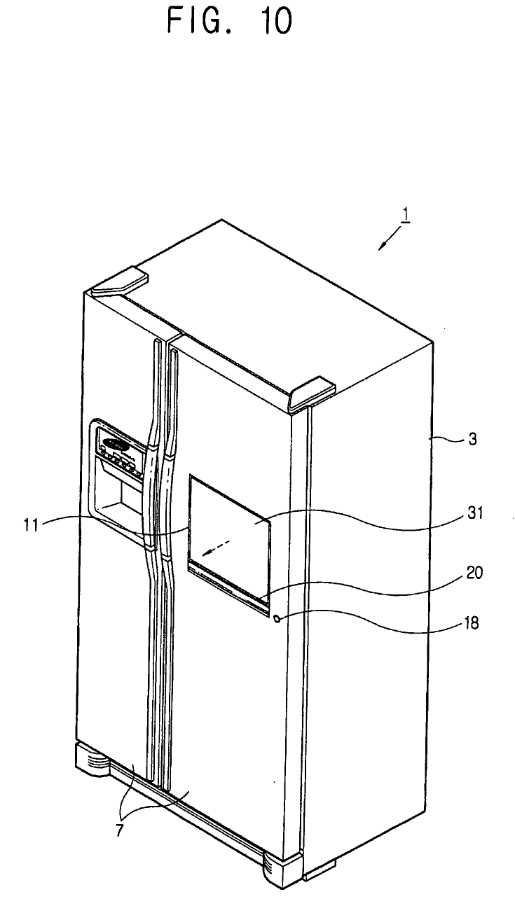

When the display 4 is separated from the support member 20, the sensor 17 of the controller 16, provided in the support member 20, may detect that the display 4 has been separated from the support member 20 and operate the driver 41. Accordingly, if the driver 41 is operated, based on the detection by the sensor 17, the connection members 51 can be lifted. Then, the support member 20 can be rotated from the separation position to the accommodation position, such that the cover member 31 moves from the opening position to the cover position, as shown in FIGS. 10 through 12. The guide cover sliders 33 of the cover member 31 are guided by the inclination guide 56 of the cover slider guide 54 and move forward along the cover member guides 13. Then, the cover member 31 moves from the opening position to the cover position, as shown in FIG. 12. The support slider 23 of the support member 20 is, thus, guided by the second support guide 59 of the support slider guide 57, and pressed by the elastic member 28 to rotate backward. Here, the support member 20 rotates from the separation position to the accommodation position, as shown in FIG. 12.

Hereinafter, the mounting of the display 4, to the display accommodator 10, will be further described. As shown in FIGS. 10 through 12, when the support member 20 is positioned in the accommodation position and the cover member 31 is positioned in the cover position, a user may actuate the control unit 18, for example. Then, the driver 41 may be driven to move the connection members 51 downward. As shown in FIGS. 7 through 9, the driver 41 can move the support member 20 from the accommodation position to the separation position, and move the cover member 31 from the cover position to the opening position. Then, if a user remounts the display 4 in the support member 20 the support member 20 can be moved to the separation position. Here, as soon as the display 4 is supported by the support member 20, the sensor 17 of the controller 16, provided in the support member 20, may detect that the display 4 has been mounted and operates the driver 41. If the driver 41 is driven, according to the detection by the sensor 17, the connection members 51 move down, such that the support member 20 rotates from the separation position to the accommodation position. Thus, the display 4 may be mounted in the display accommodator 10, e.g., provided in the door 7 of the refrigerator 1.

As the mounting of the display 4 in the display accommodator 10 is similar to that of separating the display 4 from the display accommodator 10, the detailed description thereof will be further avoided.

Thus, according to embodiments of the present invention, a user may easily separate and/or mount the display 4 with respect to the display accommodator 10. Here, as the support member 20 automatically moves from the separation position to the accommodation position only with operations of separating and mounting the display 4, with respect to the support member 20 by the controller, a user may use the display without difficulty. In addition, according to an embodiment of the present invention, the cover member 31 may be provided to cover the display accommodator 10 when the display 4 is separated from the support member 20, thereby offering an attractive external appearance of the refrigerator 1. According to a further embodiment of the present invention, as the support member 20 and the cover member 31 may be driven by a single driver 41, the configuration of the refrigerator 1 may be further simplified.

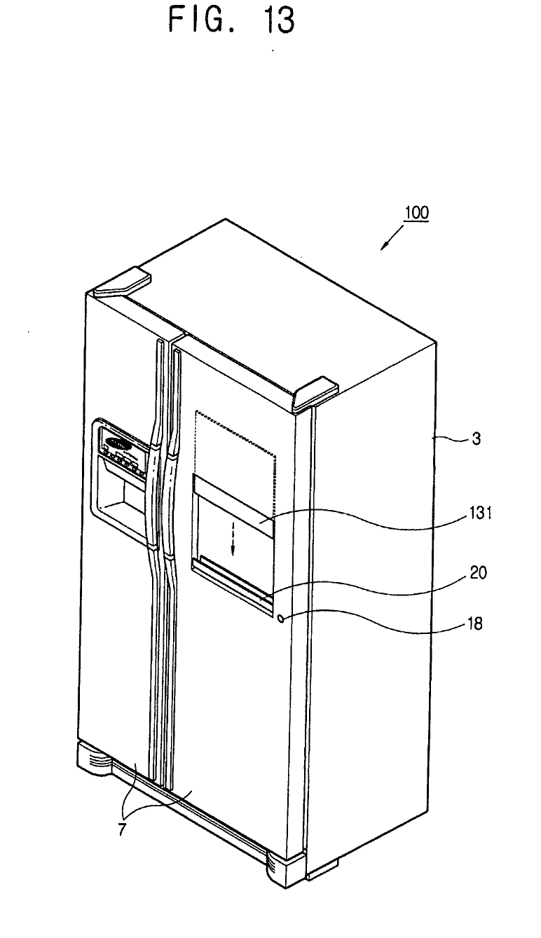

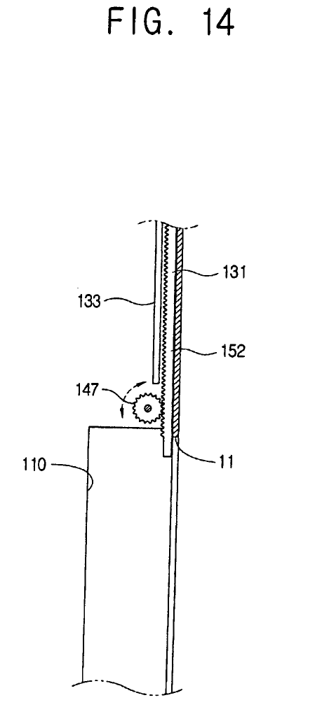

FIGS. 13 and 14 are further perspective and partial sectional illustrations of a cover unit of a refrigerator, according to another embodiment of the present invention. Here, a cover member 131 may move from a first side to a second side of an opening 11 of a display accommodator 110. That is, the cover member 131 may move in a vertical direction to move between an opening position to open the opening 11 of the display accommodator 110 and a cover position to cover the opening 11 of the display accommodator 110.

Alternatively, according to another embodiment of the present invention, the cover member 131 may move in the horizontal direction to move between the opening position and the cover position. The rack gear 152 may be provided in a rear surface of the cover member 131 to move the cover member 131 by a driving motor (not shown) and a pinion gear 147, for example.

A cover member accommodator 133 may be provided along a first side of the display accommodator 110 to accommodate the cover member 131. Preferably, a rear part of the display accommodator 110 may be closed to support a display 4, disposed in an accommodation position. A cover guide (not shown) may further be provided in the display accommodator 110 to guide the cover member 131 in a moving direction.

The cover member accommodator 133 may be disposed along an upper part of the display accommodator 110.

Thus, the cover member 131 may move to the opening position and the cover position by rotating the pinion gear 147, as dictated by a sensor (not shown) provided in a control unit 18 or a support member 20, for example.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A storage compartment, comprising:
a display accommodator to accommodate a display;
a support member to support the display and to move the display between an accommodation position, where the display is accommodatable in the display accommodator, and a separation position, where the display is separatable from the display accommodator;
a driver to move the support member to/from the accommodation position and/or the separation position; and
a controller to detect whether the display is separate from the support member and to drive the driver to correspondingly move the support member to/from the separation position to/from the accommodation position.

2. The storage compartment of claim 1, wherein the storage compartment is a refrigerator.

3. The storage compartment of claim 1, further comprising a display accommodatable in the display accommodator.

4. The storage compartment of claim 3, wherein the display comprises a connection port and the support member comprises a connector to couple with the connection port of the display.

5. The storage compartment of claim 1, wherein the display accommodator is formed in a door providing access to the storage compartment.

6. The storage compartment of claim 1, wherein the controller detects whether the display is supported by the support member and drives the driver to move the support member from the separation position to the accommodation position.

7. The storage compartment of claim 6, wherein the support member is provided in a lower portion of the display accommodator to rotate between the accommodation position and the separation position.

8. The storage compartment of claim 7, further comprising a support slider in the support member and a support slider guide to be moved by the driver and to guide the support slider to rotate the support member between the accommodation position and the separation position.

9. The storage compartment of claim 8, further comprising an elastic member to press the support member toward the accommodation position.

10. The storage compartment of claim 1, further comprising a cover member to move to an opening position to open the display accommodator for access of the display to the support member.

11. The storage compartment of claim 10, wherein the cover member moves between the opening position and a cover position, to cover the display accommodator when the display is separate from the support member

12. The storage compartment of claim 11, wherein the display accommodator comprises a cover member guide to guide the cover member forward and backward, and the cover member comprises a cover slider to be guided by the cover member guide.

13. The storage compartment of claim 12, further comprising a connection member connected to the driver and the cover slider to move the cover slider along the cover member guide by the driver.

14. The storage compartment of claim 13, wherein the connection member moves in a traverse direction to a moving direction of the cover member by the driver and comprises a cover member slider guide to guide the cover slider by movement of the connection member.

15. The storage compartment of claim 14, wherein the cover slider guide comprises an inclination guide inclined toward the moving direction of the connection member.

16. The storage compartment of claim 15, wherein the cover slider guide further comprises a parallel guide connected with the inclination guide and formed in the moving direction of the connection member.

17. The storage compartment of claim 16, further comprising a support slider provided in the support member and a support slider guide, movable by the driver, to guide the support slider to rotate the support member between the accommodation position and the separation position, wherein
the support slider rotates between the accommodation position and the separation position when the cover slider is guided by the parallel guide and the inclination guide respectively.

18. The storage compartment of claim 17, wherein the support slider guide is provided in the connection member.

19. The storage compartment of claim 18, wherein the driver comprises a driving motor and a pinion gear to be rotated by the driving motor, and the connection member comprises a rack gear to engage the pinion gear.

20. The storage compartment of claim 1, wherein the controller comprises a sensor provided in the support member to detect whether the display is separated and/or mounted with respect to the support member.

21. The storage compartment of claim 20, wherein the controller further comprises a control unit to control the driver to rotate the support member to the accommodation position and the separation position.

22. A storage compartment comprising, comprising:
a display accommodator having an opening to accommodate a display;
a support member to support the display;
a cover member to move to an opening position and/or cover position to respectively open and/or close the opening of the display accommodator; and
a driver to drive the cover member to move to the opening position and/or the cover position.

23. The storage compartment of claim 22, wherein the cover member moves between the opening position and cover position to correspondingly open and cover the opening of the display accommodator based upon the display being respectively separated from or inserted into the support member.

24. The storage compartment of claim 22, wherein the storage compartment is a refrigerator.

25. The storage compartment of claim 22, further comprising a display accommodatable in the display accommodator.

26. The storage compartment of claim 22, wherein the display accommodator is formed in a door providing access to the storage compartment.

27. The storage compartment of claim 22, wherein the display accommodator comprises a cover member guide to guide the cover member forward and backward, and the cover member comprises a cover slider to be guided by the cover member guide.

28. The storage compartment of claim 22, further comprising a connection member connected to the driver and the cover slider to move the cover slider along the cover member guide by the driver.

29. The storage compartment of claim 28, wherein the connection member moves in a traverse direction to a moving direction of the cover member, by operation of the driver, and comprises a cover slider guide to guide the cover slider by movement of the connection member.

30. The storage compartment of claim 29, wherein the cover slider guide comprises an inclination guide inclined toward the moving direction of the connection member.

31. The storage compartment of claim 30, wherein the cover slider guide further comprises a parallel guide connected with the inclination guide and formed in the moving direction of the connection member.

32. The storage compartment of claim 31, wherein the driver comprises a driving motor and a pinion gear to rotate, by operation of the driving motor, and the connection member comprises a rack gear to engage the pinion gear.

33. The storage compartment of claim 32, wherein the support member rotates, by operation of the driver, between an accommodation position, where the display is accommodated in the display accommodator, and a separation position, where the display is separated from the display accommodator.

34. The storage compartment of claim 33, further comprising a sensor to detect whether the display is attached and/or detached to the support member and to apply a corresponding operation signal to the driver to rotate the support member respectively to/from the separation position to/from the accommodation position.

35. The storage compartment of claim 34, further comprising a control unit to control the driver to rotate the support member to/from the accommodation and/or the separation positions.

36. The storage compartment of claim 22, wherein the cover member moves from a first side to a second side of the opening of the display accommodator.

37. The storage compartment of claim 36, wherein the first side of the display accommodator comprises a cover member accommodator to accommodate the cover member.

38. The storage compartment of claim 37, wherein the display accommodator comprises a cover guide to guide the cover member.

39. A refrigerator comprising a main body enclosing a storage compartment and a door to provide access to the storage compartment, further comprising:
a display;
a display accommodator formed in the door to accommodate the display;
a support member to support the display and to move the display between an accommodation position, where the display is accommodated in the display accommodator, and a separation position, where the display is separated from the display accommodator;
a driver to move the support member to/from the accommodation position and the separation position;
a cover member to move between an opening position, to open an opening of the display accommodator, and a cover position, to cover the opening of the display accommodator, when the display is separated from the support member by the driver; and
a controller to detect whether the display is supported by, and whether the display is separated from, the support member and to correspondingly drive the driver to move the support member from the separation position to the accommodation position.

40. The refrigerator according to claim 39, further comprising a connection member provided between the driver and the cover member to move the cover member by the driver.

41. The refrigerator according to claim 40, wherein the driver comprises a driving motor and a pinion gear to rotate, by operation of the driving motor, and the connection member comprises a rack gear to engage the pinion gear.

42. A storage compartment display accommodation method, comprising:
providing support for a display, with the support being capable of moving the display between an accommodation position, where the display is accommodatable in a display accommodator, and a separation position, where the display is separatable from the display accommodator; and
moving the display accomodator to/from the accommodation position and/or the separation position based upon a detection of whether the display is separate from the display accommodator.

43. A storage compartment display accommodation method, comprising:
providing support for a display, with the support being capable of moving the display between an accommodation position, where the display is accommodatable in a display accommodator, and a separation position, where the display is separatable from the display accommodator; and
moving a cover member to an opening position and/or cover position to open and/or respectively open or close an opening of the display accommodator.
